(19) United States
(12) Patent Application Publication
(10) Pub. No.: US 2023/0195664 A1
(43) Pub. Date: Jun. 22, 2023

(54) SOFTWARE MANAGEMENT OF DIRECT MEMORY ACCESS COMMANDS

(71) Applicants: ADVANCED MICRO DEVICES, INC., Santa Clara, CA (US); ATI TECHNOLOGIES ULC, Markham (CA)

(72) Inventors: Sean KEELY, Santa Clara, CA (US); Joseph L. GREATHOUSE, Santa Clara, CA (US); Hari THANGIRALA, Santa Clara, CA (US); Alan D. SMITH, Santa Clara, CA (US); Milind N. NEMLEKAR, Santa Clara, CA (US)

(21) Appl. No.: 17/558,798

(22) Filed: Dec. 22, 2021

(51) Int. Cl. G06F 13/28; G06F 13/16

(52) U.S. Cl. CPC G06F 13/28; G06F 13/1668

(57) ABSTRACT

A method for software management of DMA transfer commands includes receiving a DMA transfer command instructing a data transfer by a first processor device. Based at least in part on a determination of runtime system resource availability, a device different from the first processor device is assigned to assist in transfer of at least a first portion of the data transfer. In some embodiments, the DMA transfer command instructs the first processor device to write a copy of data to a third processor device. Software analyzes network bus congestion at a shared communications bus and initiates DMA transfer via a multi-hop communications path to bypass the congested network bus.

### BACKGROUND

A direct memory access (DMA) engine is a module which coordinates direct memory access transfers of data between devices (e.g., input/output interfaces and display controllers) and memory, or between different locations in memory, within a computer system. A DMA engine is often located on a processor, such as a processor having a central processing unit (CPU) or a graphics processor (GPU) and receives commands from an application running on the processor. Based on the commands, the DMA engine reads data from a DMA source (e.g., a first buffer defined in memory) and writes data to a DMA destination (e.g., a second buffer defined in memory).

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a block diagram of a computing system implementing a multi-die processor in accordance with some embodiments.

FIG. 2 is a block diagram of portions of an example computing system for implementing software management of DMA commands in accordance with some embodiments.

FIG. 3 is a block diagram illustrating portions of an example multi-processor computing system for implementing software management of DMA commands in accordance with some embodiments.

FIG. 4 is a block diagram illustrating an example of a system implementing software-managed routing of transfer commands in accordance with some embodiments.

FIG. 5 is a block diagram illustrating another example of a system implementing software-managed routing of transfer commands in accordance with some embodiments.

FIG. 6 is a flow diagram illustrating a method of performing software-managed routing of DMA transfer commands in accordance with some embodiments.

### DETAILED DESCRIPTION

Conventional processors include one or more direct memory access engines to read and write blocks of data stored in a system memory. The direct memory access engines relieve processor cores from the burden of managing transfers. In response to data transfer requests from the processor cores, the direct memory access engines provide requisite control information to the corresponding source and destination such that data transfer operations can be executed without delaying computation code, thus allowing communication and computation to overlap in time. With the direct memory access engine asynchronously handling the formation and communication of control information, processor cores are freed to perform other tasks while awaiting satisfaction of the data transfer requests.

Distributed architectures are increasingly common alternatives to monolithic processing architecture in which physically or logically separated processing units are operated in a coordinated fashion via a high-performance interconnection. One example of such a distributed architecture is a chiplet architecture, which captures the advantages of fabricating some portions of a processing unit at smaller nodes while allowing other portions to be fabricated at nodes having larger dimensions if the other portions do not benefit from the reduced scales of the smaller nodes. In some cases, the number of direct memory access engines is higher in chiplet-based systems (such as relative to an equivalent monolithic, non-chiplet based design).

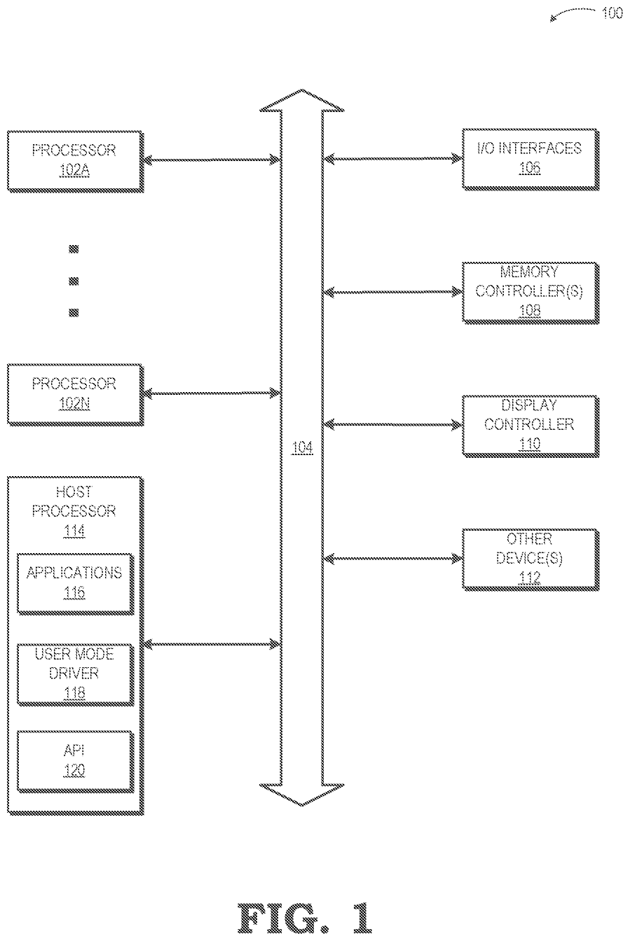

To increase system performance by improving utilization of direct memory access engines, FIGS. 1-6 illustrate systems and methods that utilize software-managed coordination between DMA engines for the processing of direct memory transfer commands. In various embodiments, a method for software management of DMA transfer commands includes receiving a DMA transfer command instructing a data transfer by a first processor device. Based at least in part on a determination of runtime system resource availability, a device different from the first processor device is assigned to assist in transfer of at least a first portion of the data transfer. In some embodiments, the DMA transfer command instructs the first processor device to write a copy of data to a third processor device. A user mode driver determines network bus congestion at a shared communications bus and initiates DMA transfer via a multi-hop communications path to bypass the congested network bus. The work specified by a transfer command is managed by software to be assigned to DMA engines and communication paths such that total bandwidth usage goes up without requiring any changes to device hardware (e.g., without each individual DMA engine needing to get bigger or have more capabilities) to increase overall DMA throughput and data fabric bandwidth usage. In this manner, system software is able to obtain increased performance out of existing hardware.

FIG. 1 illustrates a block diagram of one embodiment of a computing system 100 implementing a multi-die processor in accordance with some embodiments. In various embodiments, computing system 100 includes at least one or more processors 102A-N, fabric 104, input/output (I/O) interfaces 106, memory controller(s) 108, display controller 110, and other device(s) 112. In some embodiments, the one or more processors 102 include additional modules, not illustrated in FIG. 1, to facilitate execution of instructions, including one or more additional processing units such as one or more additional central processing units (CPUs), additional GPUs, one or more digital signal processors and the like. In various embodiments, to support execution of instructions for graphics and other types of workloads, the computing system 100 also includes a host processor 114, such as a central processing unit (CPU). In various embodiments, computing system 100 includes a computer, laptop, mobile device, server, or any of various other types of computing systems or devices. It is noted that the number of components of computing system 100 vary in some embodiments. It is also noted that in some embodiments computing system 100 includes other components not shown in FIG. 1. Additionally, in other embodiments, computing system 100 is structured in other ways than shown in FIG. 1.

Fabric 104 is representative of any communication interconnect that complies with any of various types of protocols utilized for communicating among the components of the computing system 100. Fabric 104 provides the data paths, switches, routers, and other logic that connect the processing units 102, I/O interfaces 106, memory controller(s) 108, display controller 110, and other device(s) 112 to each other. Fabric 104 handles the request, response, and data traffic, as well as probe traffic to facilitate coherency. Fabric 104 also handles interrupt request routing and configuration access paths to the various components of computing system 100. Additionally, fabric 104 handles configuration requests, responses, and configuration data traffic. In some embodiments, fabric 104 is bus-based, including shared bus configurations, crossbar configurations, and hierarchical buses with bridges. In other embodiments, fabric 104 is packet-based, and hierarchical with bridges, crossbar, point-to-point, or other interconnects. From the point of view of fabric 104, the other components of computing system 100 are referred to as “clients”. Fabric 104 is configured to process requests generated by various clients and pass the requests on to other clients.

Memory controller(s) 108 are representative of any number and type of memory controllers coupled to any number and type of memory device(s). For example, the type of memory device(s) coupled to memory controller(s) 108 include Dynamic Random Access Memory (DRAM), Static Random Access Memory (SRAM), NAND Flash memory, NOR flash memory, Ferroelectric Random Access Memory (FeRAM), or others. Memory controller(s) 108 are accessible by processors 102, I/O interfaces 106, display controller 110, and other device(s) 112 via fabric 104. I/O interfaces 106 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices are coupled to I/O interfaces 106. Such peripheral devices include (but are not limited to) displays, keyboards, mice, printers, scanners, joysticks or other types of game controllers, media recording devices, external storage devices, network interface cards, and so forth. Other device(s) 112 are representative of any number and type of devices (e.g., multimedia device, video codec).

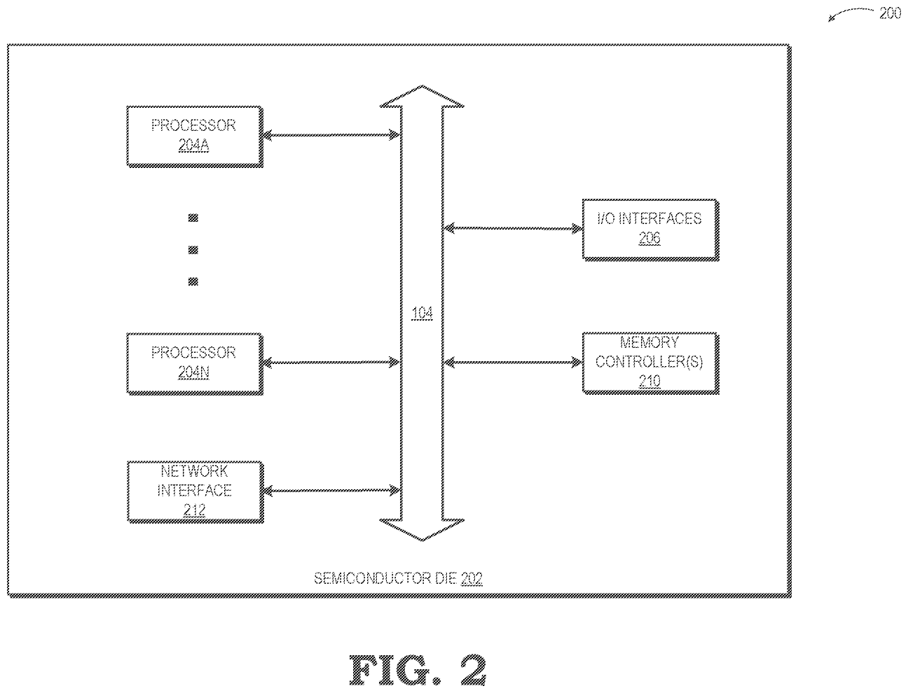

In various embodiments, each of the processors 102 is a parallel processor (e.g., vector processors, graphics processing units (GPUs), general-purpose GPUs (GPGPUs), non-scalar processors, highly-parallel processors, artificial intelligence (AI) processors, inference engines, machine learning processors, other multithreaded processing units, and the like). Each parallel processor 102 is constructed as a multi-chip module (e.g., a semiconductor die package) including two or more base integrated circuit dies (described in more detail below with respect to FIG. 2) communicably coupled together with bridge chip(s) such that a parallel processor is usable (e.g., addressable) like a single semiconductor integrated circuit. As used in this disclosure, the terms “die” and “chip” are interchangeably used. Those skilled in the art will recognize that a conventional (e.g., not multi-chip) semiconductor integrated circuit is manufactured as a wafer or as a die (e.g., single-chip IC) formed in a wafer and later separated from the wafer (e.g., when the wafer is diced); multiple ICs are often manufactured in a wafer simultaneously. The ICs and possibly discrete circuits and possibly other components (such as non-semiconductor packaging substrates including printed circuit boards, interposers, and possibly others) are assembled in a multi-die parallel processor.

In various embodiments, the host processor 114 executes a number of processes, such as executing one or more application(s) 116 that generate commands and executing a user mode driver 118 (or other drivers, such as a kernel mode driver). In various embodiments, the one or more applications 116 include applications that utilizes the functionality of the processors 102, such as applications that generate work in the system 100 or an operating system (OS). An application 116 may include one or more graphics instructions that instruct the processors 102 to render a graphical user interface (GUI) and/or a graphics scene. For example, the graphics instructions may include instructions that define a set of one or more graphics primitives to be rendered by the processors 102. Although various embodiments of DMA transfer command routing are described below in the context of runtime user mode drivers, it should be recognized that software-managed routing of DMA transfer commands is not limited to such contexts. In various embodiments, the methods and architectures described are applicable to any of a variety of software managers such as kernel mode drivers, operating system, hypervisors, and the like without departing from the scope of this disclosure.

In some embodiments, the application 116 utilizes a graphics application programming interface (API) 120 to invoke a user mode driver 118 (or a similar GPU driver). User mode driver 118 issues one or more commands to the one or more processors 102 for performing compute operations (e.g., rendering one or more graphics primitives into displayable graphics images). Based on the instructions issued by application 116 to the user mode driver 118, the user mode driver 118 formulates one or more commands that specify one or more operations for processors 102 to perform. In some embodiments, the user mode driver 118 is a part of the application 116 running on the host processor 114. For example, the user mode driver 118 may be part of a gaming application running on the host processor 114. Similarly, a kernel mode driver (not shown) may be part of an operating system running on the host processor 114.

As described in more detail with respect to FIGS. 2-6 below, in various embodiments, each of the individual processors 102 include one or more base IC dies employing processing stacked die chiplets in accordance with some embodiments. The base dies are formed as a single semiconductor chip package including N number of communicably coupled graphics processing stacked die chiplets. In various embodiments, the base IC dies include two or more DMA engines used in coordinating DMA transfers of data between devices and memory (or between different locations in memory). It should be recognized that although various embodiments are described below in the particular context of CPUs and GPUs for ease of illustration and description, the concepts described here is also similarly applicable to other processors including parallel accelerated processors (PAP) such as accelerated processing units (APUs), discrete GPUs (dGPUs), artificial intelligence (AI) accelerators, other parallel processors, and the like.

Software executing at the host processor 114 (such as runtime user mode driver 118) perform software-managed coordination of DMA transfer command execution across the various processors 102. In various embodiments, as described below with respect to FIGS. 2-6, the software management of DMA transfer commands include the routing of DMA transfer commands to system components or splitting of DMA transfer commands into smaller workloads for execution based on the determination of various system resource constraints (e.g., fabric 104 bandwidth congestion or contention for processor time), resource availability (e.g., idle processors or un-saturated communication paths), and the like. The work specified by a transfer command is managed by software to be assigned to one or more processors 102, DMA engines, and communication paths such that total bandwidth usage goes up without requiring any changes to device hardware (e.g., without each individual DMA engine needing to get bigger or have more capabilities) to increase overall DMA throughput and data fabric bandwidth usage. In this manner, system software is able to obtain increased performance out of existing hardware.

Referring now to FIG. 2, illustrated is a block diagram of portions of an example computing system 200. In some examples, computing system 200 is implemented using some or all of device 100, as shown and described with respect to FIG. 1. Computing system 200 includes at least a first semiconductor die 202. In various embodiments, semiconductor die 202 includes one or more processors 204A-N, input/output (I/O) interfaces 206, intra-die interconnect 208, memory controller(s) 210, and network interface 212. In other examples, computing system 200 includes further components, different components, and/or is arranged in a different manner. In some embodiments, the semiconductor die 202 is a multi-chip module constructed as a semiconductor die package including two or more integrated circuit (IC) dies, such that a processor may be used like a single semiconductor integrated circuit. As used in this disclosure, the terms “die” and “chip” may be interchangeably used.

In some embodiments, each of the processors 204A-N includes one or more processing devices. In one embodiment, at least one of processors 204A-N includes one or more general purpose processing devices, such as CPUs. In some implementations, such processing devices are implemented using processor 102 as shown and described with respect to FIG. 1. In another embodiment, at least one of processors 204A-N includes one or more parallel accelerated processors. Examples of parallel accelerated processors include GPUs, digital signal processors (DSPs), field programmable gate arrays (FPGAs), application specific integrated circuits (ASICs), and the.

The I/O interfaces 206 include one or more I/O interfaces (e.g., peripheral component interconnect (PCI) bus, PCI-Extended (PCI-X), PCIE (PCI Express) bus, gigabit Ethernet (GBE) bus, universal serial bus (USB), and the like). In some implementations, I/O interfaces 206 are implemented using input driver 112, and/or output driver 114 as shown and described with respect to FIG. 1. Various types of peripheral devices can be coupled to I/O interfaces 206. Such peripheral devices include (but are not limited to) displays, keyboards, mice, printers, scanners, joysticks or other types of game controllers, media recording devices, external storage devices, network interface cards, and so forth. In some implementations, such peripheral devices are implemented using input devices 108 and/or output devices 118 as shown and described with respect to FIG. 1.

In various embodiments, each processor includes a cache subsystem with one or more levels of caches. In some embodiments, each of the processors 204A-N includes a cache (e.g., level three (L3) cache) which is shared among multiple processor cores of a core complex. The memory controller 210 includes at least one memory controller accessible by processors 204A-N, such as accessible via intra-die interconnect 208. In various embodiments, memory controller 210 includes one or more of any suitable type of memory controller. Each of the memory controllers are coupled to (or otherwise in communication with) and control access to any number and type of memory devices (not shown). In some implementations, such memory devices include dynamic random access memory (DRAM), static random access memory (SRAM), NAND Flash memory, NOR flash memory, ferroelectric random access memory (FeRAM), or any other suitable memory device. The intra-die interconnect 208 includes any computer communications medium suitable for communication among the devices shown in FIG. 2, such as a bus, data fabric, or the like.

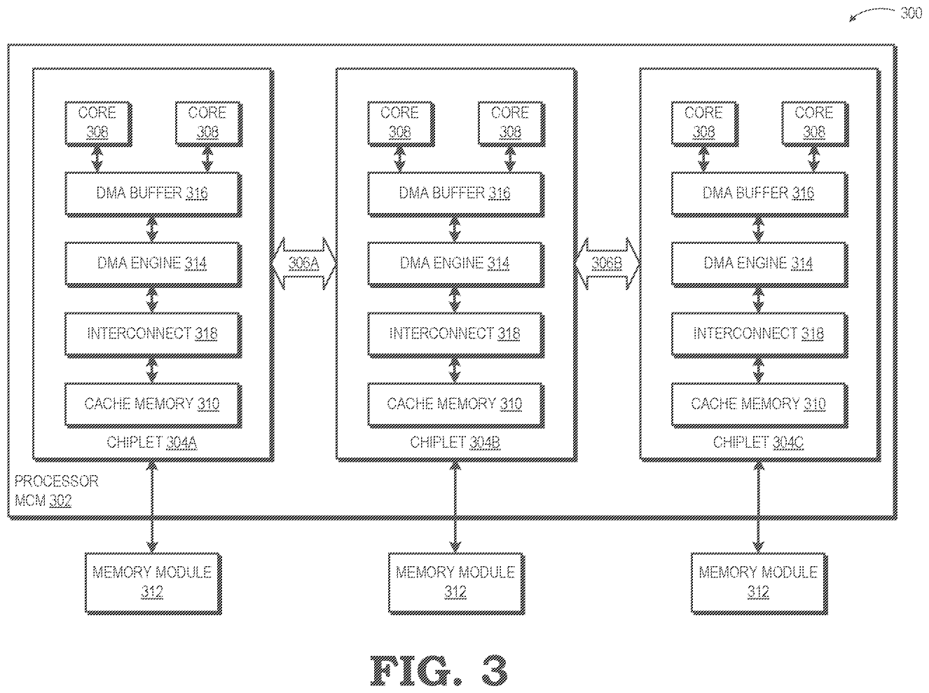

In various embodiments, as described below with respect to FIGS. 3-6, the software management of DMA transfer commands include the routing of DMA transfer commands to various system components such as the one or more processors 204A-N or splitting of DMA transfer commands into smaller workloads for execution based on the determination of various system resource constraints (e.g., fabric 104 bandwidth congestion or contention for processor time at the one or more processors 204A-N), resource availability (e.g., idle processors amongst the one or more processors 204A-N or un-saturated communication paths), and the like. The work specified by a transfer command is managed by software to be assigned to processors, DMA engines, and communication paths such that total bandwidth usage goes up without requiring any changes to device hardware (e.g., without each individual DMA engine needing to get bigger or have more capabilities) to increase overall DMA throughput and data fabric bandwidth usage. In this manner, system software is able to obtain increased performance out of existing hardware.

FIG. 3 is a block diagram illustrating portions of an example multi-processor computing system 300. System 300, or portions thereof, is implementable using some or all of semiconductor die 202 (as shown and described with respect to FIG. 2) and/or device 100 (as shown and described with respect to FIGS. 1 and 2). In various embodiments, the system 300 includes a processor multi-chip module 302 employing processing stacked die chiplets in accordance with some embodiments. The processor multi-chip module 302 is formed as a single semiconductor chip package including N=3 number of communicably coupled graphics processing stacked die chiplets 304. As shown, the processor multi-chip module 302 includes a first graphics processing stacked die chiplet 304A, a second graphics processing stacked die chiplet 304B, and a third graphics processing stacked die chiplet 304C.

It should be recognized that although the graphics processing stacked die chiplets 304 are described below in the particular context of parallel accelerated processor (e.g., GPU) terminology for ease of illustration and description, in various embodiments, the architecture described is applicable to any of a variety of types of parallel processors (such as previously described more broadly with reference to FIGS. 2 and 3) without departing from the scope of this disclosure. Additionally, in various embodiments, and as used herein, the term “chiplet” refers to any device including, but is not limited to, the following characteristics: 1) a chiplet includes an active silicon die containing at least a portion of the computational logic used to solve a full problem (i.e., the computational workload is distributed across multiples of these active silicon dies); 2) chiplets are packaged together as a monolithic unit on the same substrate; and 3) the programming model preserves the concept that the combination of these separate computational dies (i.e., the graphics processing stacked die chiplet) as a single monolithic unit (i.e., each chiplet is not exposed as a separate device to an application that uses the chiplets for processing computational workloads).

In various embodiments, the processor multi-chip module 302 includes an inter-chip data fabric 306 that operates as a high-bandwidth die-to-die interconnect between chiplets (e.g., between any combination of the first graphics processing stacked die chiplet 304A, the second graphics processing stacked die chiplet 304B, and the third graphics processing stacked die chiplet 304C). In some embodiments, the processor multi-chip module 302 include one or more processor cores 308 (e.g., CPUs and/or GPUs, or processor core dies) formed over each of the chiplets 304A-304C. Additionally, in various embodiments, each of the chiplets 304A-304C includes one or more levels of cache memory 310 and one or more memory PHYs (not shown) for communicating with external system memory modules 312, such as dynamic random access memory (DRAM) modules.

Each of the chiplets 304A-304C also includes one or more DMA engines 314. In various embodiments, the one or more DMA engines 314 coordinate DMA transfers of data between devices and memory (or between different locations in memory) within system 300. The one or more DMA engines 314 coordinate, in various embodiments, moving of data between the multiple devices/accelerators while computation(s) are performed on other data at, for example, the processor cores 308. In various embodiments, the one or more DMA engines 314 are, in some embodiments, part of a DMA controller (not shown) but the terms DMA engine and DMA controller are used interchangeably herein. The DMA engines 314, in response to commands, operates to transfer data into and out of, for example, the one or more memory modules 312 without involvement of the processor cores 308. Similarly, the DMA engines 314, in some embodiments, performs intra-chip data transfers. As will be appreciated, the DMA engines 314 relieve processor cores from the burden of managing data transfers, and in various embodiments is used as a global data transfer agent to handle various data transfer requirements from software, such as memory-to-memory data copying.

The one or more DMA engines 314 provide for fetching and decoding of command packets from application/agent queues and respective DMA buffers to perform the desired data transfer operations as specified by DMA commands, also known as descriptors. DMA commands include memory flow commands that transfer or control the transfer of memory locations containing data or instructions (e.g., read/get or write/put commands for transferring data in or out of memory). The DMA command descriptors indicate, in various embodiments, a source address from which to read the data, a transfer size, and a destination address to which the data are to be written for each data transfer operation. The descriptors are commonly organized in memory as a linked list, or chain, in which each descriptor contains a field indicating the address in the memory of the next descriptor to be executed. In various embodiments, the descriptors are also an array of commands with valid bits, where the command is of a known size and the one or more DMA engines 314 stop when it reaches an invalidate command. The last descriptor in the list has a null pointer in the “next descriptor” field, indicating to the DMA engine that there are no more commands to be executed, and DMA should become idle once it has reached the end of the chain.

In response to data transfer requests from the processor cores, the DMA engines 314 provide the requisite control information to the corresponding source and destination so that the data transfer requests are satisfied. Because the DMA engines 314 handle the formation and communication of the control information, processor cores are freed to perform other tasks while awaiting satisfaction of the data transfer requests. In various embodiments, each of the DMA engines 314 include one or more specialized auxiliary processor(s) that transfer data between locations in memory and/or peripheral input/output (I/O) devices and memory without intervention of processor core(s) or CPUs.

In some embodiments, demand for DMA is handled by placing DMA commands generated by one or more of the processor cores 308 in memory mapped IO (MMIO) locations such as at DMA buffer(s) 316 (also interchangeably referred to as DMA queues for holding DMA transfer commands). In various embodiments, the DMA buffer is a hardware structure into which read or write instructions are transferred such that the DMA engines 314 can read DMA commands out of (e.g., rather than needing to go to DRAM memory). To perform data transfer operations, in various embodiments, the DMA engines 314 receive instructions (e.g., DMA transfer commands/data transfer requests) generated by the processor cores 308 by accessing a sequence of commands in the DMA buffer(s) 316. The DMA engines 314 then retrieves the DMA commands (also known as descriptors) from the DMA buffer(s) 316 for processing. In some embodiments, the DMA commands specify, for example, a start address for direct virtual memory access (DVMA) and I/O bus accesses, and a transfer length up to a given maximum.

Although the DMA buffer(s) 316 are illustrated in FIG. 3 as being implemented at the chiplets 304 for ease of illustration, those skilled in the art will recognize that the DMA buffer(s) 316 are implementable at various components of the systems and devices described herein without departing from the scope of this disclosure. For example, in some embodiments, the DMA buffer(s) 316 are configured in main memory such as at memory modules 312. That location of the command queue in memory is where DMA engines 314 go to read transfer commands. In various embodiments, the DMA buffer(s) 316 are further configured as one or more ring buffers (e.g., addressed by modulo-addressing).

The DMA engines 314 accesses DMA transfer commands (or otherwise receives commands) from the DMA buffer(s) 316 over a bus (not shown). Based on the received instructions, in some embodiments, the DMA engines 314 read and buffer data from any memory (e.g., memory modules 312) via the data fabric 306, and write the buffered data to any memory via the data fabric 306. In some implementations, a DMA source and DMA destination are physically located on different devices (e.g., different chiplets). Similarly, in multi-processor systems, the DMA source and DMA destination are located on different devices associated with different processors in some cases. In such cases, the DMA engine 314 resolves virtual addresses to obtain physical addresses, and issues remote read and/or write commands to affect the DMA transfer. For example, in various embodiments, based on the received instructions, DMA engines 314 send a message to a data fabric device with instructions to affect a DMA transfer.

During DMA, the one or more processor cores 308 queue DMA commands in the DMA buffer(s) 316 and can signal their presence to the DMA engines 314. For example, in some embodiments, an application program running on the system 300 prepares an appropriate chain of descriptors in memory accessible to the DMA engine (e.g., DMA buffers 316) to initiate a chain of DMA data transfers. The processor cores 308 then sends a message (or other notification) to the DMA engine 314 indicating the memory address of the first descriptor in the chain, which is a request to the DMA engine to start execution of the descriptors. The application typically sends the message to the “doorbell” of the DMA engine—a control register with a certain bus address that is specified for this purpose. Sending such a message to initiate DMA execution is known as “ringing the doorbell” of the DMA engine 314. The DMA engine 314 responds by reading and executing the first descriptor. It then updates a status field of the descriptor to indicate to the application that the descriptor has been executed. The DMA engine 314 follows the “next” field through the entire linked list, marking each descriptor as executed, until it reaches the null pointer in the last descriptor. After executing the last descriptor, the DMA engine 314 becomes idle and is ready to receive a new list for execution.

In various embodiments, such as illustrated in FIG. 3, the system 300 includes two or more accelerators connected together by the inter-chip data fabric 306. In particular, a first inter-chip data fabric 306A communicably couples the first graphics processing stacked die chiplet 304A to the second graphics processing stacked die chiplet 304B. Similarly, a second inter-chip data fabric 306B communicably couples the second graphics processing stacked die chiplet 304B to the third graphics processing stacked die chiplet 304C. Further, as illustrated in FIG. 3, the components of the graphics processing stacked die chiplets 304 (e.g., the one or more processor cores 308, DMA engines 314, DMA buffers 316, and the like) are in communication with each other over interconnect 318 (e.g., via other components).

In this manner, the interconnect 318 forms part of a data fabric which facilitates communication among components of multi-processor computing system 300. Further, the inter-chip data fabric 306 extends the data fabric over the various communicably coupled graphics processing stacked die chiplets 304 and I/O interfaces (not shown) which also form part of the data fabric. In various embodiments, the interconnect 318 includes any computer communications medium suitable for communication among the devices shown in FIG. 3, such as a bus, data fabric, and the like. In some implementations, the interconnect 318 is connected to and/or in communication with other components, which are not shown in FIG. 3 for ease of description. For example, in some implementations, interconnect 318 includes connections to one or more input/output (I/O) interfaces 206 such as shown and described with respect to FIG. 2.

As will be appreciated, the inter-chip data fabric 306 and/or the interconnects 318 often have such a high bandwidth (such as in modern architectures with a larger number of buses and interconnects between system components, particularly in high performance computing and machine learning systems) that a single DMA engine is not capable of saturating available data fabric bandwidth. In various embodiments, and as described in more detail below, the system 300 utilizes the increased number of DMA engines 314 (e.g., one per chiplet 304 as illustrated in the embodiment of FIG. 3) to perform software-managed routing of transfer commands to multiple DMA engines 314 for processing of memory transfer commands via DMA. In this manner, the work specified by a transfer command is routed across multiple chiplets 304 and their respective DMA engines 314 such that total bandwidth usage goes up without each individual DMA engine 314 needing to get bigger or have more capabilities to increase overall DMA throughput and data fabric bandwidth usage.

During operation, in response to notifications (e.g., doorbell rings), the DMA engine 314 reads and executes the DMA transfer commands (with its associated parameters) from the DMA buffers 316 to execute data transfer operations and packet transfers. In various embodiments, the operation parameters (e.g., DMA command parameters) are usually the base address, the stride, the element size and the number of elements to communicate, for both the sender and the receiver sides. In particular, the DMA engines 314 are configured such that multiple DMA engines 314 across multiple dies (e.g., MCMs 302) or chiplets 304 read that same location containing the packet with DMA transfer parameters. Subsequently, as described in more detail below, system software (e.g, user mode driver 118 of FIG. 1) synchronizes the DMA engines 314 to cooperatively work on the DMA transfer. In various embodiments, the user mode driver performs software-managed splitting and coordinates the DMA engines 314 such that a singular DMA engine only performs part of the DMA transfer. For example, splitting of the DMA transfer between two DMA engines 314 has the potential to double bandwidth usage or DMA transfer throughput per unit time, as each individual DMA engine is performing half the transfer at the same time as the other DMA engine.

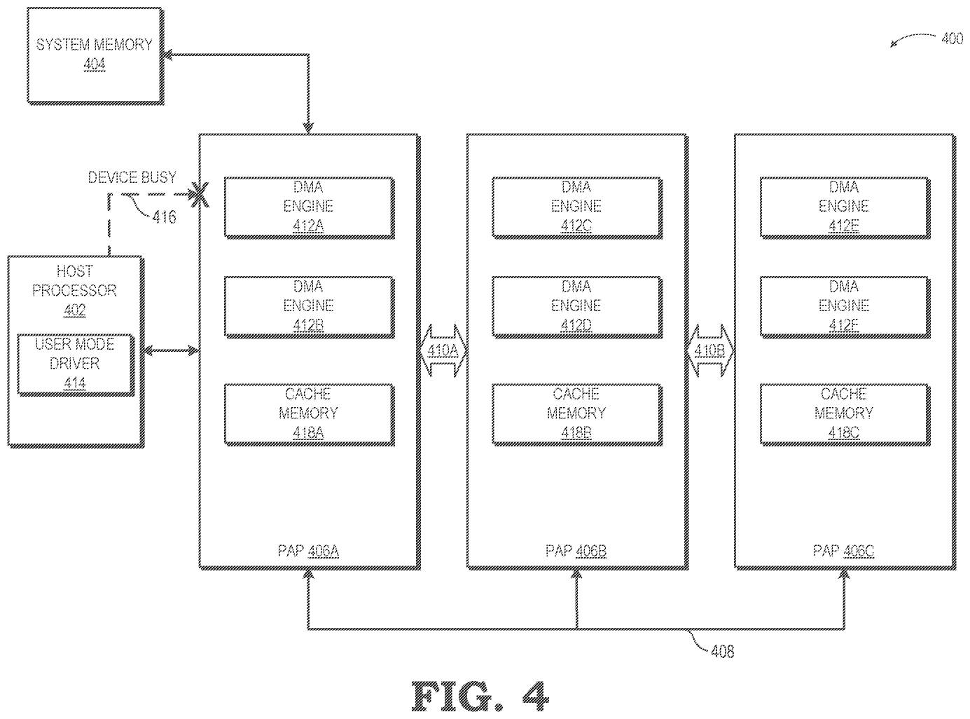

Referring now to FIG. 4, illustrated is a block diagram illustrating an example of a system implementing software-managed routing of transfer commands in accordance with some embodiments. System 400, or portions thereof, is implementable using some or all of semiconductor die 202 (as shown and described with respect to FIG. 2) and/or system 100 (as shown and described with respect to FIGS. 1 and 2). In various embodiments, the system 400 includes at least a host processor 402, a system memory 404, and one or more PAPs 406. In various embodiments, the host processor 402, the system memory 404, and one or more PAPs 406 are implemented as previously described with respect to FIGS. 1-3. Those skilled in the art will appreciate that system 400 also includes additional components such as software, hardware, and firmware components in addition to, or different from, that shown in FIG. 4. In various embodiments, the PAPs 406 include other components, omits one or more of the illustrated components, has multiple instances of a component even if only one instance is shown in FIG. 4, and/or is organized in other suitable manners.

In various embodiments, the system 400 executes any of various types of software applications. In some embodiments, as part of executing a software application (not shown), the host processor 402 of system 400 launches tasks to be executed at the PAPs 406. For example, when a software application executing at the host processor 402 requires graphics processing, the host processor 402 provides graphics commands and graphics data in a command buffer in the system memory 404 (e.g., implemented as dynamic random access memory (DRAM), static random access memory (SRAM), nonvolatile RAM, or other type of memory) for subsequent receival and processing by the PAPs 406. Depending on the embodiment, software commands are generated by a user application, a user mode driver, or another software application.

The system 400 includes N=3 number of communicably coupled PAPs 406. As shown, the system 400 includes a first PAP 406A, a second PAP 406B, and a third PAP 406C that are communicably coupled together with one or more I/O interfaces 408 that provide a communications interface between, for example, the host processor 402, the system memory 404, and the one or more PAPs 406. Such as previously described with respect to FIG. 1, the I/O interfaces 408 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). However, other embodiments of the interface I/O interfaces 408 are implemented using one or more of a bridge, a switch, a router, a trace, a wire, or any combination thereof.

In various embodiments, the system 400 also includes one or more inter-chip data fabrics 410 that operates as high-bandwidth die-to-die interconnects between PAPs. Additionally, in various embodiments, each of the PAPs 406 includes one or more levels of cache memory 418 and one or more memory PHYs (not shown) for communicating with external system memory modules, such as system memory module 404. When considered as a whole, the main memory (e.g., system memory module 404) communicably coupled to the multiple PAPs 406 and their local caches form the shared memory for the device 400. As will be appreciated, each PAP 406 only has a direct physical connection to a portion of the whole share memory system.

In various embodiments, each PAP 406 includes one or more DMA engines 412 (e.g., a first DMA engine 412A and a second DMA engine 412B positioned at the first PAP 406A). In various embodiments, the DMA engines 412 coordinate DMA transfers of data between devices and memory (or between different locations in memory) within system 400. The DMA engines 412 coordinate, in various embodiments, moving of data between the multiple devices/accelerators while computation(s) are performed on other data at, for example, processor cores (not shown) of the PAPs 406. In various embodiments, the one or more DMA engines 412 are, in some embodiments, part of a DMA controller (not shown) but the terms DMA engine and DMA controller are used interchangeably herein. The DMA engines 412, in response to commands, operates to transfer data into and out of, for example, device memory (e.g., cache memory 418 of each PAP 406, PAP associated memory modules, system memory module 404, and the like) without involvement of the processor cores. Similarly, the DMA engines 412, in some embodiments, performs intra-device transfers.

It should be recognized that although described here in the particular context of GPU terminology for ease of illustration and description, in various embodiments, the architecture described is applicable to any of a variety of types of parallel processors (such as previously described more broadly with reference to FIGS. 2 and 3) without departing from the scope of this disclosure. Further, although described here in the particular context of a multi-PAP device, those skilled in the art will recognize that the software-managed splitting of transfer commands is not limited to that particular architecture and may be performed in any system configuration including monolithic dies, architectures with CPUs and GPU co-located on the same die, chiplet-based architecture such as previously described with respect to FIG. 3, and the like.

In various embodiments, the user space and software applications executing at the host processor 402 (such as user mode driver 414) has a more holistic view and understanding of system resource constraints, particularly relative to individual system components such as each individual PAP 406. In some instances, for example, the user mode driver 414 determines with a degree of confidence exceeding a predetermined threshold that compute operations running at the one or more PAPs 406 (e.g., currently performing a large amount of compute work) are scheduled such that a conventional DMA transfer will complete in time before the requested data is needed. In such circumstances, increasing DMA throughput and having DMA transfers complete faster would not improve system operations (and therefore it would not be computationally profitable or energy efficient). Therefore, the system 400 determines to perform conventional DMA and/or turns on fewer DMA engines for performing DMA transfers.

However, as will be appreciated, there are various circumstances in which the system 400 benefits from performing software-managed splitting of DMA transfer commands. As illustrated in FIG. 4, the one or more PAPs 406 include the first PAP 406A, the second PAP 406B, and the third PAP 406C that are able to read and/or write each other's memory. A command from software, such as DMA command 416, is targeted to the first PAP 406A to move data from memory of the first PAP 406A to the memory of the second PAP 406B. However, the first PAP 406A is currently busy and therefore unable to respond to the read or write DMA commands (e.g., DMA transfer commands/data transfer requests). In various embodiments, due to the ability of software such as the user mode driver 414 to understand that DMA transfer command at run time and understand that there are multiple places for the DMA command 416 to be routed, the user mode driver 414 is configured to recruit various other resources to perform the read or writes as instructed by the DMA command 416. For example, in one embodiment, the user mode driver 414 recruits a different PAP (e.g., the second PAP 406B or the third PAP 406C) if it is currently idle to perform the DMA command 416 originally targeted to the first PAP 406A.

In another embodiment, the DMA command 416 is a command from software to move data from memory of the first PAP 406A (e.g., cache memory 418A) into memory of the second PAP 406B (e.g., cache memory 418B). Conventionally, because the PAPs 406 are not configured to coordinate with each other due to being separate devices, such a DMA transfer is performed by turning on one of the DMA engines 412 (e.g., DMA engine 412A) at the first PAP 406A, reading the data out of its own memory, and writing to its peer (i.e., the second PAP 406B) via a communications path such as the I/O interfaces 408 or the inter-chip data fabric 410A between the first PAP 406A and the second PAP 406B.

To perform software-managed routing of the DMA command 416, the user mode driver 414 instead (or in addition to the DMA engine 412A) turns on DMA engine 412A at the first PAP 406A and copies the requested data from local memory to its peer (e.g., DMA engine 412C the second PAP 406B). The user mode driver 414 also turns on DMA engine 412C at the second PAP 406B to copy from the peer DMA engine 412C into its local memory at the second PAP 406B. Such operations are conventionally not possible as the DMA engines do not have knowledge that each other exist due to being on different devices. Similarly, it should be recognized that the resources recruited for performing the DMA transfer operations are not limited to DMA engines at the source and destination devices. In other embodiments, DMA engines at an idle third PAP 406C are recruited by the user mode driver 414 to read data out of the first PAP 406A for storage into the second PAP 406B. That is, a device that is not involved in either side of the transfer is, in various embodiments, recruited to perform the DMA transfer due to its availability to perform work.

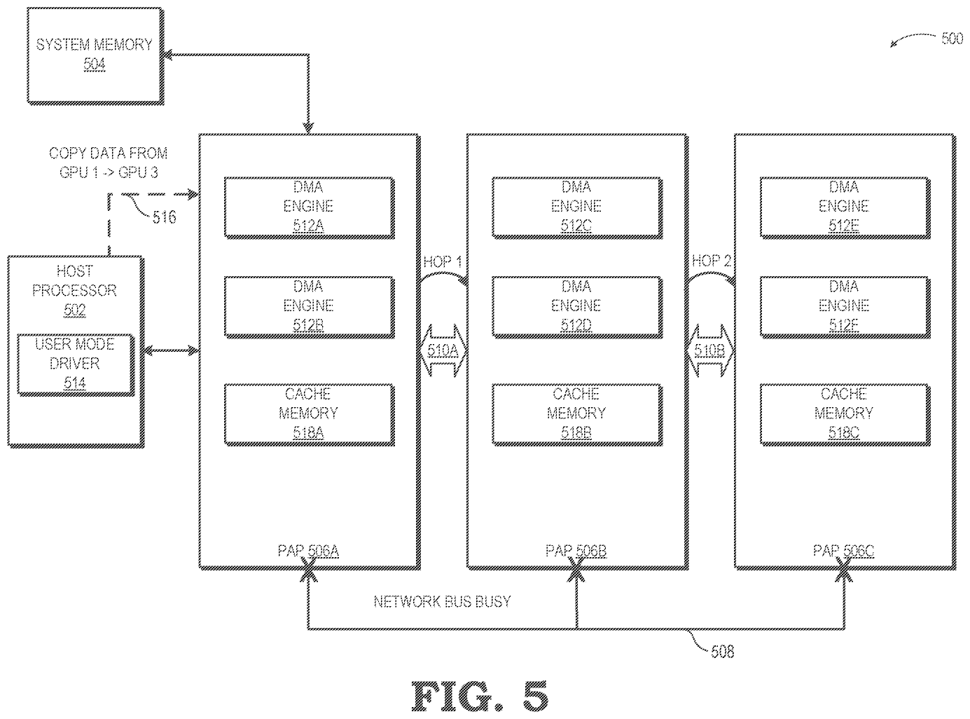

In other embodiments, such as described in more detail below, software determines routing of DMA transfer commands based on network congestion status and bandwidth availability (instead of looking at processing hardware contention such as described in FIG. 4). Referring now to FIG. 5, illustrated is a block diagram illustrating another example of a system implementing software-managed routing of transfer commands in accordance with some embodiments. System 500, or portions thereof, is implementable using some or all of semiconductor die 202 (as shown and described with respect to FIG. 2) and/or system 100 (as shown and described with respect to FIGS. 1 and 2). In various embodiments, the system 500 includes at least a host processor 502, a system memory 504, and one or more PAPs 506. In various embodiments, the host processor 502, the system memory 504, and one or more PAPs 506 are implemented as previously described with respect to FIGS. 1-3. Those skilled in the art will appreciate that system 400 also includes additional components such as software, hardware, and firmware components in addition to, or different from, that shown in FIG. 4. In various embodiments, the PAPs 506 include other components, omits one or more of the illustrated components, has multiple instances of a component even if only one instance is shown in FIG. 5, and/or is organized in other suitable manners.

In various embodiments, the system 500 executes any of various types of software applications. In some embodiments, as part of executing a software application (not shown), the host processor 502 of system 500 launches tasks to be executed at the PAPs 506. For example, when a software application executing at the host processor 502 requires graphics processing, the host processor 502 provides graphics commands and graphics data in a command buffer in the system memory 504 (e.g., implemented as dynamic random access memory (DRAM), static random access memory (SRAM), nonvolatile RAM, or other type of memory) for subsequent receival and processing by the PAPs 506. Depending on the embodiment, software commands are generated by a user application, a user mode driver, or another software application.

The system 500 includes N=3 number of communicably coupled PAPs 506. As shown, the system 400 includes a first PAP 506A, a second PAP 506B, and a third PAP 506C that are communicably coupled together with one or more I/O interfaces 508 that provide a communications interface between, for example, the host processor 502, the system memory 504, and the one or more PAPs 506. Such as previously described with respect to FIG. 1, the I/O interfaces 508 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). However, other embodiments of the I/O interfaces 508 are implemented using one or more of a bridge, a switch, a router, a trace, a wire, or any combination thereof.

In various embodiments, the system 500 also includes one or more inter-chip data fabrics 510 that operates as high-bandwidth die-to-die interconnects between PAPs. Additionally, in various embodiments, each of the PAPs 506 includes one or more levels of cache memory 518 and one or more memory PHYs (not shown) for communicating with external system memory modules, such as system memory module 504. When considered as a whole, the main memory (e.g., system memory module 504) communicably coupled to the multiple PAPs 506 and their local caches form the shared memory for the device 500. As will be appreciated, each PAP 506 only has a direct physical connection to a portion of the whole share memory system.

In various embodiments, each PAP 506 includes one or more DMA engines 512 (e.g., a first DMA engine 512A and a second DMA engine 512B positioned at the first PAP 506A). In various embodiments, the DMA engines 512 coordinate DMA transfers of data between devices and memory (or between different locations in memory) within system 500. The DMA engines 512 coordinate, in various embodiments, moving of data between the multiple devices/accelerators while computation(s) are performed on other data at, for example, processor cores (not shown) of the PAPs 506. In various embodiments, the one or more DMA engines 512 are, in some embodiments, part of a DMA controller (not shown) but the terms DMA engine and DMA controller are used interchangeably herein. The DMA engines 512, in response to commands, operates to transfer data into and out of, for example, device memory (e.g., cache memory 518 of each PAP 506, PAP associated memory modules, system memory module 504, and the like) without involvement of the processor cores. Similarly, the DMA engines 512, in some embodiments, performs intra-device transfers.

It should be recognized that although described here in the particular context of GPU terminology for ease of illustration and description, in various embodiments, the architecture described is applicable to any of a variety of types of parallel processors (such as previously described more broadly with reference to FIGS. 2 and 3) without departing from the scope of this disclosure. Further, although described here in the particular context of a multi-GPU device, those skilled in the art will recognize that the software-managed splitting of transfer commands is not limited to that particular architecture and may be performed in any system configuration including monolithic dies, architectures with CPUs and GPUs co-located on the same die, chiplet-based architecture such as previously described with respect to FIG. 3, and the like.

In various embodiments, the user space and software applications executing at the host processor 502 (such as user mode driver 514) has a more holistic view and understanding of system resource constraints, particularly relative to individual system components such as each individual PAP 506. Further, software has better ability (such as relative to hardware) to look at global state of system operations and can also take advantage of data path links that are currently idle or less congested with traffic or oversubscribed at any given time.

As shown, system 500 includes a plurality of PAPs 506 (e.g., the first PAP 506A, the second PAP 506B, and the third PAP 506C) communicably coupled to a shared I/O interface 508 (e.g., point-to-point PCIE system). Additionally, the system 500 includes direct connections between the PAPs 506 that are not shared by that I/O interface 508 such that each hardware device is only aware of its direct links. For example, the first inter-chip data fabric 410A is a direct, unshared link between the first PAP 506a and the second PAP 506B that is unknown to the third PAP 506C. Similarly, the second inter-chip data fabric 510B is a direct, unshared link between the second PAP 506B and the third PAP 506C that is unknown to the first PAP 506A.

A command from software, such as DMA command 516, is targeted to the first PAP 506A to move data from memory of the first PAP 506A to the memory of the third PAP 506C. However, the I/O interface 508 is currently congested (e.g., saturated with network traffic) and therefore unable to timely transport the data associated with the DMA command 516. In various embodiments, due to the ability of software such as the user mode driver 514 to understand that DMA transfer command at run time and understand that there are multiple paths for data associated with the DMA command 516 to be routed, the user mode driver 514 is configured to recruit various other resources to perform the read or writes as instructed by the DMA command 516.

As those skilled in the art will appreciate, given a sufficiently large network system, there can be multiple indirect links by which communications can take one or more extra hops across the communications network to complete the DMA transfer. Software (e.g., user mode driver 514) monitors network congestion across the entire communications network including, for example, the I/O interface 508, the inter-chip data fabrics, and other communication paths (not shown) between components of system 500. In one embodiment, the user mode driver 514 recruits the second PAP 506B to assist in the DMA transfer by instructing DMA engine 512A at the first PAP 506A to read the requested data out of its own memory and write the requested data to the second PAP 506B via inter-chip data fabric 510A (instead of the congested I/O interface 508). Subsequently, the user mode driver 514 instructs DMA engine 512C at the second PAP 506B to write the requested data to the third PAP 506C via inter-chip data fabric 510B (instead of the congested I/O interface 508).

In this manner, the user mode driver 514 routes DMA traffic across globally less congested communications links and completes the data transfer requested by DMA command 516 in two hops by recruiting usage of the inter-chip data fabrics 510. As will be appreciated, each hardware device only knows of its direct connection to its neighbors and can only choose its least congested local link (but which may be a globally sub-optimal decision because the less congested local link may still be more congested relative to other non-direct links and paths through the system). Software is better suited for tailoring the routing and/or splitting of DMA transfer command policies for applications at run time. In some embodiments, software decides, for example, that for certain copies of data or copies when a system component is in a certain use state (e.g., currently busy or network congested) to split or route a DMA transfer command differently than if a system component was idle.

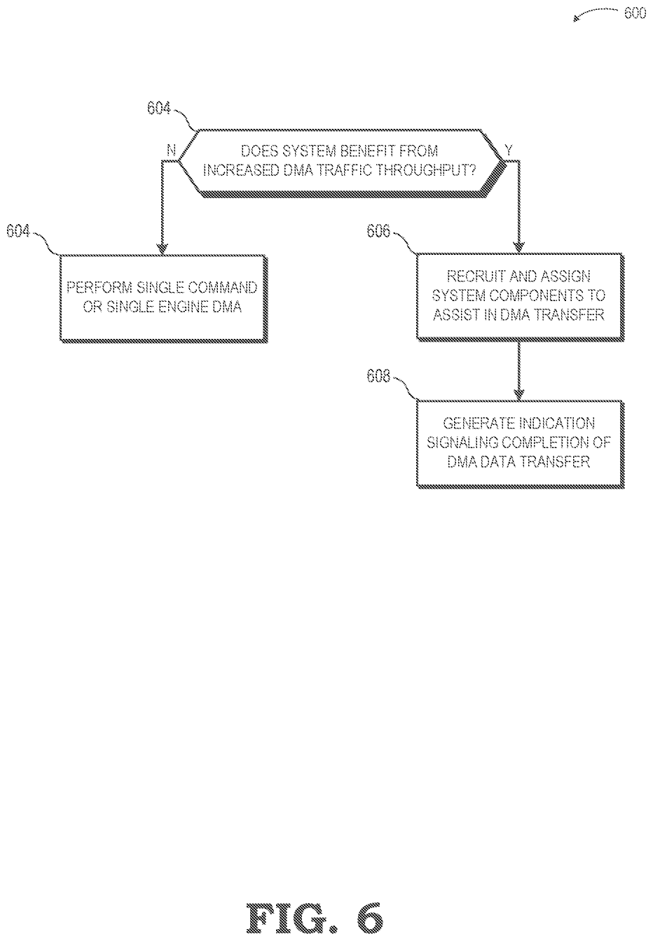

FIG. 6 is a block diagram of a method 600 of performing software-managed routing of DMA transfer commands in accordance with some embodiments. For ease of illustration and description, the method 600 is described below with reference to and in an example context of the systems and devices of FIGS. 1-5. However, the method 600 is not limited to these example contexts, but instead in different embodiments is employed for any of a variety of possible system configurations using the guidelines provided herein.

The method 600 begins at block 602 with the determining, by software, as to whether the system would benefit from increased DMA traffic throughput. For example, such as previously described in more detail with respect to FIG. 4, the user mode driver 414 determines that compute operations running at the one or more PAPs 406 (e.g., currently performing a large amount of compute work) are scheduled such that a conventional DMA transfer will complete in time before the requested data is needed. In such circumstances, increasing DMA throughput and having DMA transfers complete faster would not improve system operations (and therefore it would not be computationally profitable or energy efficient). In such circumstances, the method 600 proceeds to block 604 at which the user mode driver instructs a single DMA engine to perform the transfer and/or turn on fewer DMA engines for performing DMA transfers.

However, as will be appreciated, there are various circumstances in which the system benefits from performing software-managed routing and/or splitting of DMA transfer commands. Accordingly, the method 600 continues at block 606 with recruiting of one or more system components to assist in completing the data transfer requested by a DMA transfer command. For example, such as illustrated in FIG. 4, DMA command 416 is targeted to the first PAP 406A to move data from memory of the first PAP 406A to the memory of the second PAP 406B. However, the first PAP 406A is currently busy and therefore unable to respond to the read or write DMA commands (e.g., DMA transfer commands/data transfer requests). In one embodiment, the user mode driver 414 recruits a different PAP (e.g., the second PAP 406B or the third PAP 406C) if it is currently idle to perform the DMA command 416 originally targeted to the first PAP 406A.

In another embodiment, the DMA command 416 is a command from software to move data from memory of the first PAP 406A (e.g., cache memory 418A) into memory of the second PAP 406B (e.g., cache memory 418B). To perform software-managed routing of the DMA command 416, the user mode driver 414 instead recruits (or in addition to the DMA engine 412A) other system components by turning on DMA engine 412A at the first PAP 406A and copying the requested data from local memory to its peer (e.g., DMA engine 412C the second PAP 406B). The user mode driver 414 also turns on DMA engine 412C at the second PAP 406B to copy from the peer DMA engine 412C into its local memory at the second PAP 406B. In other embodiments, DMA engines at an idle third PAP 406C are recruited by the user mode driver 414 to read data out of the first PAP 406A for storage into the second PAP 406B. That is, a device that is not involved in either side of the transfer is, in various embodiments, recruited to perform the DMA transfer due to its availability to perform work.

In other embodiments, such as illustrated with respect to FIG. 5, a command from software, such as DMA command 516, is targeted to the first PAP 506A to move data from memory of the first PAP 506A to the memory of the third PAP 506C. However, the I/O interface 508 is currently congested (e.g., saturated with network traffic) and therefore unable to timely transport the data associated with the DMA command 516. Software (e.g., user mode driver 514) monitors network congestion across the entire communications network including, for example, the I/O interface 508, the inter-chip data fabrics, and other communication paths (not shown) between components of system 500. In one embodiment, the user mode driver 514 recruits the second PAP 506B to assist in the DMA transfer by instructing DMA engine 512A at the first PAP 506A to read the requested data out of its own memory and write the requested data to the second PAP 506B via inter-chip data fabric 510A (instead of the congested I/O interface 508). Subsequently, the user mode driver 514 instructs DMA engine 512C at the second PAP 506B to write the requested data to the third PAP 506C via inter-chip data fabric 510B (instead of the congested I/O interface 508).

It should be recognized that the software-managed recruiting of system components to assist in DMA transfers and the routing of DMA transfer commands has primarily been described here in the context of routing whole packets of transfer commands for ease of description and illustration. However, those skilled in the art will recognize that the software-managed execution of DMA transfers is not limited to that particular level of execution granularity and that a single DMA transfer command may be split by software to be performed by two or more DMA engines at various system locations based on system congestion and/or resource contention without departing from the scope of this disclosure.

In some embodiments, for example, the user mode driver 514 splits a single DMA transfer command/job description into two or more smaller workloads and recruits different system resources to execute those smaller workloads. With reference to FIG. 5, such a splitting may include submitting a first DMA job notification instructing a first DMA engine 512A at the first PAP 506A to perform a first half of the DMA transfer via the I/O interface 508 and a second DMA job notification instructing a second DMA engine 512B at the first PAP 506A to perform a second half of the DMA transfer via the inter-chip data fabric 510A. The software-managed allocation of workloads includes, in some embodiments, interleaving (not necessarily evenly) the workload amongst multiple DMA engines and data transfer paths dependent upon resource availability.

Additionally, it should be recognized that although primarily described here in the context of software-recruitment of DMA engines to assist in executing DMA transfers, the software-managed recruiting of system components is applicable to various other devices or system components without departing from the scope of this disclosure. In some embodiments, the user mode driver also turns on one or more compute engines, CPUs, or other processors to perform data reads and writes. Those devices still perform DMA, just no longer at a copy only DMA engine. For example, in one embodiment, software-managed recruiting of system components to assist in DMA transfers includes splitting a single DMA transfer command/job description into two or more smaller workloads, and assigning a first of the smaller workloads for a portion of the transfer to be executed by a DMA engine on one PAP device. At least a second of the smaller workloads with its respective portion of the transfer is assigned by the user mode driver to a compute engine on a different PAP device. In this manner, software runtime selects from various components of a broad system component portfolio (including processor cores, DMA engines, compute engines, and the like) to optimize for performance and minimize energy use.

At block 608, after transferring one or more portions of the data transfer (dependent upon whether the DMA transfer command is split into multiple smaller workloads), an indication is generated that signals completion of the data transfer requested by the DMA transfer command. For example, such as illustrated in FIG. 4, the DMA engines 414 signal that the DMA transfer is completed, such as by sending an interrupt signal to the host processor 402.

Accordingly, as discussed herein, the software-managed coordination of routing or splitting a whole DMA transfer packet and performance of the DMA transfer by recruited system components provides for work specified by a transfer command to be assigned to DMA engines (or other available processing and network bus resources) such that total bandwidth usage goes up without requiring any changes to device hardware (e.g., without each individual DMA engine needing to get bigger or have more capabilities), thereby increase overall DMA throughput and data fabric bandwidth usage. In this manner, system software is able to obtain increased performance out of existing hardware without requiring the multiple DMA engines to have paths for communicating with each other or requiring hardware/firmware to synchronize between them.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method, comprising:
receiving a direct memory access (DMA) transfer command instructing a data transfer by a first processor device; and
assigning, based at least in part on a determination of runtime system resource availability, a device different from the first processor device to assist in transfer of at least a first portion of the data transfer.

2. The method of claim 1, wherein assigning the device different from the first processor device further comprises:
initiating, based at least in part on the determination, transfer of a second portion of the data transfer by a second processor device.

3. The method of claim 2, further comprising:
initiating a first DMA engine at the first processor device to transfer a copy of data corresponding to the DMA transfer command to a second DMA engine at the second processor device; and
initiating the second DMA engine to transfer the copy of data to a local memory of the second processor device.

4. The method of claim 2, further comprising:
initiating a third DMA engine at a third processor device to read a copy of data corresponding to the DMA transfer command from a first DMA engine and write the copy of data to a local memory of a second processor device.

5. The method of claim 1, wherein the DMA transfer command instructs the first processor device to write a copy of data to a second processor device.

6. The method of claim 5, further comprising:
determining of network bus congestion at a common input/output interface shared by the first processor device, a second processor device, and a third processor device;
initiating transfer of the copy of data from the first processor device to the second processor device via a first direct inter-chip data fabric between the first processor device and the second processor device; and
initiating transfer of the copy of data from the second processor device to the third processor device via a second direct inter-chip data fabric between the second processor device and the third processor device.

7. The method of claim 5, further comprising:
determining network bus congestion at a common input/output interface shared by the first processor device, a second processor device, and a third processor device;
splitting of the DMA transfer command into a plurality of smaller workloads; and
initiating transfer of at least a first portion of the data transfer corresponding to one of the plurality of smaller workloads via a multi-hop communications path between the first processor device and the third processor device.

8. A processor device, comprising:
a first base integrated circuit (IC) die including a plurality of processing stacked die chiplets 3D stacked on top of the first base IC die, wherein the first base IC die includes an inter-chip data fabric communicably coupling the plurality of processing stacked die chiplets together; and
a plurality of direct memory access (DMA) engines 3D stacked on top of the first base IC die, wherein the plurality of DMA engines are each configured to perform at least a portion of a DMA transfer command assigned based at least in part on a determination of runtime system resource availability.

9. The processor device of claim 8, further comprising:
a first DMA engine at the first base IC die configured to transfer, based on instructions during software runtime, a copy of data corresponding to the DMA transfer command to a second DMA engine at a second base IC die.

10. The processor device of claim 9, wherein the second DMA engine is further configured to transfer, based on instructions during software runtime, the copy of data to a local memory of the second base IC die.

11. The processor device of claim 9, further comprising:
a third DMA engine at a third base IC die configured to transfer, based on instructions during software runtime, a copy of data corresponding to the DMA transfer command from the first base IC die to a local memory of a second base IC die.

12. The processor device of claim 11, further comprising:
a common input/output interface shared by the first base IC die, the second base IC die, and the third base IC die.

13. The processor device of claim 12, further comprising:
a first direct inter-chip data fabric communicably coupling the first base IC die to the second base IC die; and
a second direct inter-chip data fabric communicably coupling the second base IC die to the third base IC die, wherein the first and second direct inter-chip data fabrics are configured to provide a multi-hop communications path between the first base IC die and the third base IC die during network bus congestion at the common input/output interface.

14. The processor device of claim 13, wherein the first DMA engine at the first base IC die is configured to transfer data corresponding to a first portion of the DMA transfer command after splitting into smaller workloads via the multi-hop communications path between the first base IC die and the third base IC die.

15. The processor device of claim 14, wherein a second DMA engine at the first base IC die is configured to transfer data corresponding to a second portion of the DMA transfer command after splitting into smaller workloads via the common input/output interface.

16. A system, comprising:
a host processor communicably coupled to a plurality of processor devices, wherein the host processor is configured to assign, based at least in part on a determination of runtime system resource availability, a device different from a first processor device to assist in transfer of at least a first portion of a direct memory access (DMA) transfer command targeted to the first processor device.

17. The system of claim 16, further comprising:
a second processor device of the plurality of processor devices configured to transfer a second portion of the DMA transfer command.

18. The system of claim 1617, wherein the DMA transfer command instructs the first processor device to write a copy of data to a third processor device.

19. The system of claim 18, further comprising:
a first direct inter-chip data fabric communicably coupling the first processor device to the second processor device; and
a second direct inter-chip data fabric communicably coupling the second processor device to the third processor device, wherein the first and second direct inter-chip data fabrics are configured to provide a multi-hop communications path between the first processor device and the third processor device during network bus congestion at a common input/output interface shared by the plurality of processor devices.

20. The system of claim 19, wherein the multi-hop communications path is configured to transfer data corresponding to a first portion of the DMA transfer command after splitting into smaller workloads.
